(19) United States
(12) Patent Application Publication
(10) Pub. No.: US 2002/0051248 A1
(43) Pub. Date: May 2, 2002

(54) Automatic surface deviation detector and method of use

(76) Inventors: Stacy S. Cook, Austin, TX (US); Albert D. Edgar, Austin, TX (US); Gordon D. Ford, Round Rock, TX (US)

Correspondence Address: LOCKE LIDDELL & SAPP LLP, 600 TRAVIS, 3400 CHASE TOWER, HOUSTON, TX, 77002-3095, US

(21) Appl. No.: 09/752,092

(22) Filed: Dec. 29, 2000

Related U.S. Application Data
(60) Provisional application No. 60/173,908, filed on Dec. 29, 1999.

(51) Int. Cl. H04N 1/04

(52) U.S. Cl. 358/488

(57) ABSTRACT

A surface deviation detector and method of its use capable of detecting surface deviations associated with the edge of a document placed on the platen of a scanner. Though this detector and its method of use may be accomplished by a variety of techniques, the use of slide or transparency adapters, infrared light sources, or a plurality of light sources capable of generating shadows at document edges are preferable. Moreover, the inclusion of truncating areas of the pre-scan image not associate with the document image or rotation the document image to reduce the angle of deviation to present the document image in a more vertical position are preferable.

### CROSS REFERENCES TO RELATED APPLICATIONS

This application relies on U.S. patent application Ser./Ser. No. 60/173,908 which was filed on Dec. 29, 1999.

### FIELD OF THE INVENTION

This invention and its method of use relate to the detection of surface deviations, and more particularly a method and apparatus for automatically detecting the edges of documents placed on scanners for truncation and/or rotation of the document image.

### BACKGROUND OF THE INVENTION

Scanners are input devices for computing devices. In a typical embodiment, a computing device such as a personal computer comprises software called scanner drivers that are activated by an application such as a graphics program. A computer user activates the scanner driver via the application. In turn, the scanner driver instructs the scanner to initiate a procedure called a pre-scan. In a conventional scanner, the scanner would activate and perform a low-resolution scan of the entire platen of the scanner.

As the scanner collected information from the document placed on the surface of the platen, this information was transmitted to the computer and displayed in the form of a low-resolution pre-scan. This pre-scan usually required significant manual intervention from the user prior to being ready for high-resolution scan.

For example, the image of the document does not generally fill the pre-scan window. This meant that the user had to select the area of interest using a graphics application or similar application. Using another input device such as a mouse, keyboard, or touch screen, the computer user had to manually indicate the boundaries of document image. Once the user had manually selected the boundaries of document image, the user would usually have to initiate a second scan of this preferred area. The time and effort used in focusing the pre-scan on the document represented a significant factor in productivity.

Though the pre-scanning and sizing of one document represented what may be termed a hassle, batch operations of numerous documents multiply this delay time such that a significant expenditure of time and resources was necessary. Moreover, because this low resolution pre-scan contained a significant amount of information not relevant to document, it was likely that the document image would not be shown with enough specificity and resolution to allow the user to meaningfully interact with the application.

Scanning presented a second complication. If the user did not exercise extreme care in placing the document on the platen of the scanner, the document would be scanned such that the document image would be skewed to create an angle of deviation in the pre-scan. In conventional scanners, it was generally necessary for the user to not only perform the time-consuming operations discussed above, but to use applications capable of rotating the document image. Not only did this process require applications capable of performing this function, but also a user would typically have to engage in a trial and error method of rotating the document in order to properly align the document and reduce this skew angle of deviation. This rotation procedure not only required a greater level of expertise with the application, provided the application was capable of this function, but the user would have to expend significant time, effort, and resources in manipulating each document that had been scanned.

Previous efforts to overcome these deficiencies have required the inclusion of detector elements in the platen of the scanner or in the scanner cover. Moreover, the mechanical feeding mechanisms in an automatic document-feeding context have only been marginally successful.

Therefore, a need exists for a device and a method of using this device such that documents may be scanned and available for exploitation by the user without the user's intervention to properly size a document and, if necessary, correct any skew angle of deviation as a result of the scanning process.

### SUMMARY OF THE INVENTION

One of the embodiments of the present invention and its method of use provide a user scanning at least one document with a device and its method of use that will detect surface deviations related to the edges of each document and present a digital image of the document without significant irrelevant information such as pre-scan area not comprising the document image. Moreover, this device and its method of use may further comprise the ability to correct skew angle deviations from a vertical position that have occurred as a result of imprecise placement of each document on the platen of the scanner.

The present invention reduces the amount of time necessary to perform these functions to create a high-resolution scan of the relevant information related to the boundaries of each document image from each document placed on the platen of a scanner. Some embodiments of the present invention are able to detect surface deviations associated with the edges of a document being scanned without using complex edge detection routines that absorb valuable processor time in the computing device. Several preferred configurations of the surface deviation detector and its method of use are disclosed and claimed herein.

By using differential illumination in one preferable method of the present invention, variations in the heights of objects placed on the scanning platen are detectable by using a plurality of light sources. Effectively, a more accurate scan area comprising relevant information in the form of information scanned from the document results in a faster scanning operation with greater detail that requires less user intervention.

Alternatively, in scanners equipped with slide and/or transparency adapters or similar backlighting devices, a high contrast is detectable between the image area associated with the document image and the scan image not associated with the document image. This contrast can be used to define the edges of the document image. In this embodiment, the scanner may first perform a low-resolution scan to detect image boundaries formed by the surface deviations associated with the slide adapter.

Alternatively, another embodiment of the invention may use a backlit device such as a transparency adapter to perform a transmissive scan. The document image and the devices related to the edges of the document image that would be detectable from this scan. In this arrangement, the scanner will automatically start a high-resolution reflective scan based on the findings from the low-resolution scan. Because the image area is more quickly defined, the high-resolution scan may automatically initiate without user intervention. In a preferred embodiment, both the backlit scan and the reflective scan may be performed in the same pass by either alternating scanning at a high frequency or performing both scans simultaneously and discerning the difference based on the known ranges of the optical sources using software.

In another embodiment of the present invention, an imaging system have an infrared light source and detector operates to detect surface deviations associated with the edges of the document without interference from color information related to the image. The device and method disclosed herein may simply seek the edges or be configured for greater precision by being able to identify surface deviations associated with the edges of the document from other surface deviations such as cracks, smudges, fingerprints, hairs, creases, and similar surface deviations.

In an embodiment in which the image boundary detection is incorporated into image correction software, the present invention is generally faster and more reliable than many previous automated edge detection methods. The advantages of the present invention are multiplied in batch processing of numerous documents.

Once the document image has been defined by detecting surface deviations associated with the edges of the document, the present device and its method of use may include software or similar written instructions to reduce the angle of deviation with respect to the document image in comparison to the vertical position and present the document image in an unskewed fashion for high-resolution scan and manipulation by the user using applications.

### BRIEF DESCRIPTION OF THE DRAWINGS

FIG. 1 is a perspective view of an embodiment of a reflective scanner;

FIG. 2 is a perspective view of an embodiment of a reflective scanner;

FIG. 3 is a perspective view of representative document image shown in a pre-scan on a monitor;

FIG. 4 is a front, partial view of a preferred embodiment of the present invention;

FIG. 4A is a perspective view of a preferred embodiment of the present invention wherein the scanner cover is shown in exploded view to allow for better viewing of the elements of the scanner including a backlit transparency adapter;

FIG. 5 is a perspective view of a preferred embodiment of the present invention wherein the scanner cover is shown in exploded view to allow for better viewing of the elements of the scanner;

FIG. 6 is a perspective view of a preferred embodiment of the present invention wherein the scanner is shown in a partial, close-up view to allow for better viewing of the elements of the scanner;

FIG. 7 is a front, partial view of a pre-scan display showing surface deviation images in associated with the document image;

FIG. 8 is a perspective view of a preferred embodiment of the present invention wherein the scanner is shown in transmission alignment to allow for better viewing of the elements of the scanner;

FIG. 9 is a block diagram of the functions that are performed to detect surface deviations in a preferred embodiment of the invention;

FIG. 10 is a block diagram of the functions that are performed to detect surface deviations in a preferred embodiment of the invention;

FIG. 11 is a front, partial view of a pre-scan display showing the skew angle of deviation associated with a representative document image; and

FIG. 12 is a front, partial view of a pre-scan display showing the skew angle of deviation associated with a representative document image wherein the pre-scan not associated with a representative document image has been reduced.

### DETAILED DESCRIPTION OF PREFERRED EMBODIMENT

As used herein, document refers to any representation of information expressed in a tangible medium that may be scanned using a scanner and may include documents, photographs, postcards, business cards, and/or letters. Moreover, document image as used herein refers to the digital representation of the information associated from a scan of a document.

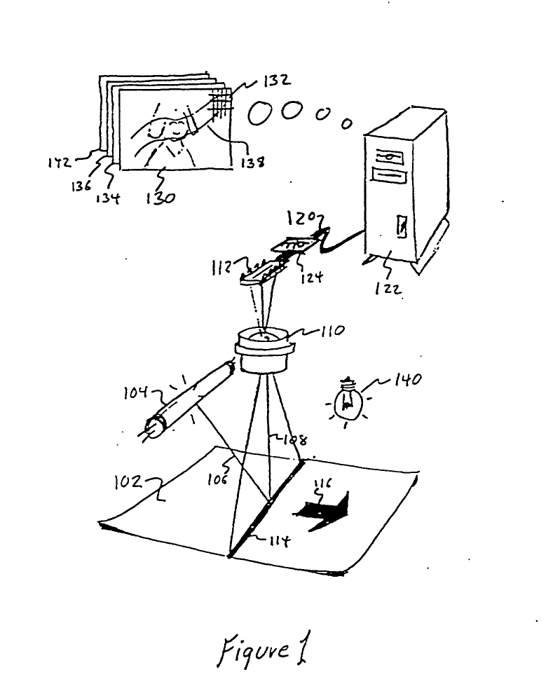

FIG. 1 portrays a representative apparatus to provide reflection scanning. In this figure, a reflection original, such as a document 102, as shown by example a reflection photographic print, is illuminated by a light source 104. A light path 106 from the light source 104 reflects from the print 102 as ray 108, and is focused by lens 110 onto a sensor 112.

The sensor 112 typically may be a linear silicon sensor array such that, when focused by lens 110, it senses at any single time a line of points defining the scanning line 114 on the print 102. As time progresses, the print 102 is moved in direction 116 so that all points on the print 102 sequentially pass under the scanning line 114 and are sensed by the sensor 112.

The sensor 112 is attached by cable 120 to a computer or similar processing device 122. Associated with the sensor 112 are converter electronics 124 that convert the analog signal from the sensor 112 into scan data which are digital numbers fed to the computer 122. Inside the computer 122, the scan data representing the image 130 is stored as a memory array consisting of an array of individual numbers 132 called picture elements or pixels.

Typically, the sensor array 112 contains three lines, each line behind a filter of a different color, to scan three images simultaneously and produce multiple channels 133, 134, and 136 of the image 130, each representing a different primary color. Under the wavelength of infrared light as described herein, all color dyes pass the infrared light and the image information functionally disappears. Under infrared light as discussed herein, the sensor 112 one sees a “blank” document with surface deviations.

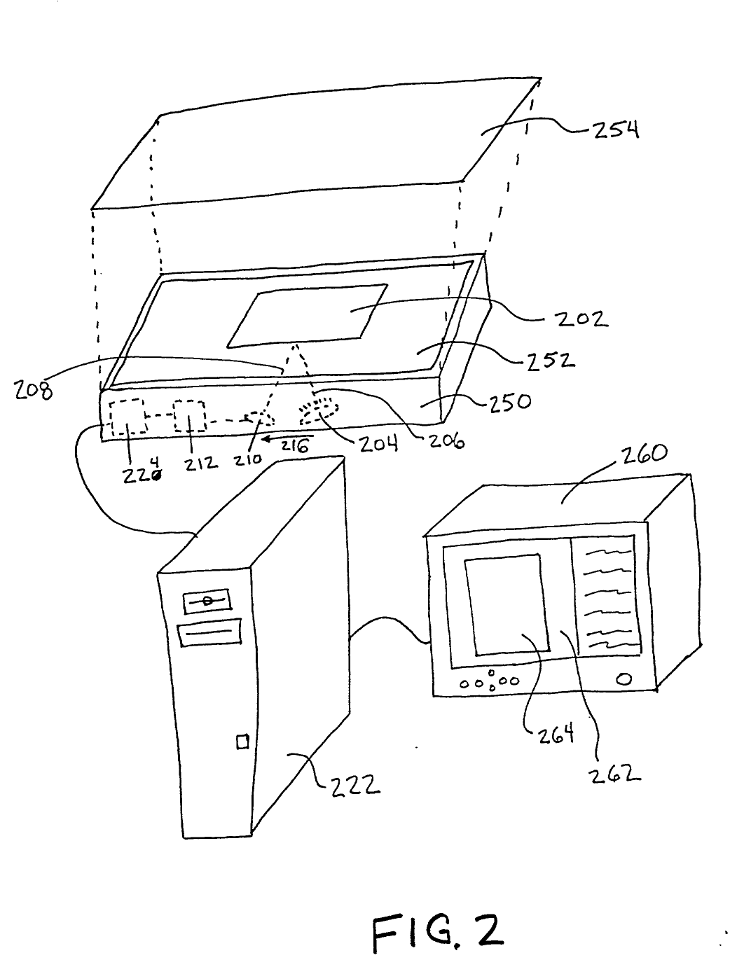

As shown in FIG. 2, a scanner 250 collects information from the document 202 placed on the platen 252 of the scanner 250. This information is transmitted to the computer 222 and displayed in the form of a pre-scan image 262 on an output device such as a monitor 260. A representative pre-scan image 262 comprises document image 264 of document 202.

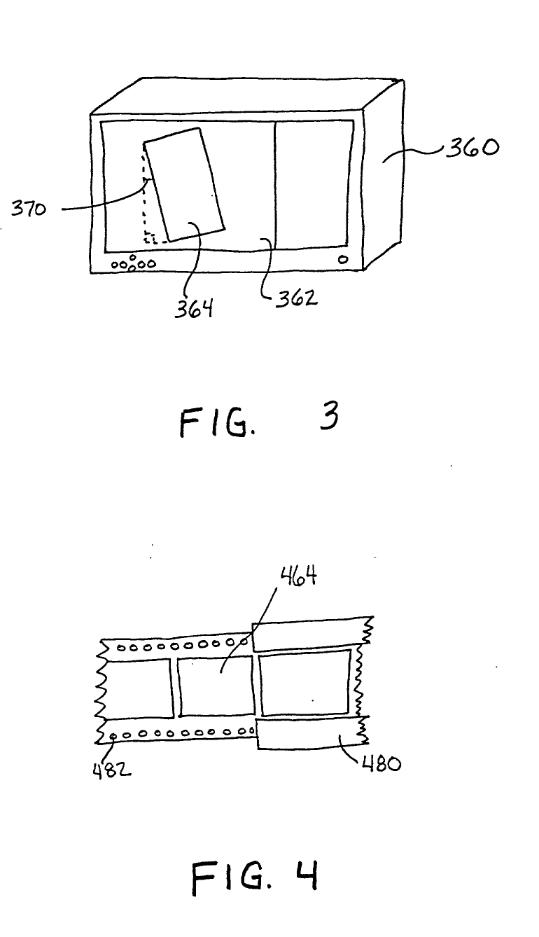

As shown in FIG. 3, a representative pre-scan of a document 302 (not shown), document 302 has been imaged to render a pre-scan image 362 with document image 364 being displayed on monitor 360. Pre-scan image 362 comprises information not relevant to the information of document image 364. As shown, document 302—perhaps as a result of imprecise placement on a scanner 350 (not shown) on platen 352 (not shown)—is skewed to create an angle of deviation 370 between the presentation of document image 364 in a vertical orientation.

Regardless of the method of detecting surface deviations that are related to the edges of the document, documents placed on the platen of a scanner are likely to be arranged such that an angle of deviation 370 exists between the edge of the document image 364 and proper vertical orientation. Users place documents on the platen of a scanner and attempt to exercise great care in the placement of these documents. Inevitably, users waste valuable time attempting to align these documents on the placement and then must spend additional time manipulating the pre-scan image or scanned image to reduce this angle of deviation 370. Though a variety of methods of the reduction of non-relevant information in pre-scan area 362 will be evident to those skilled in the art, embodiments and methods exist that provide preferable alternatives to assist in the detection of surface deviations associated with the edges of each document placed on the platen of a scanner.

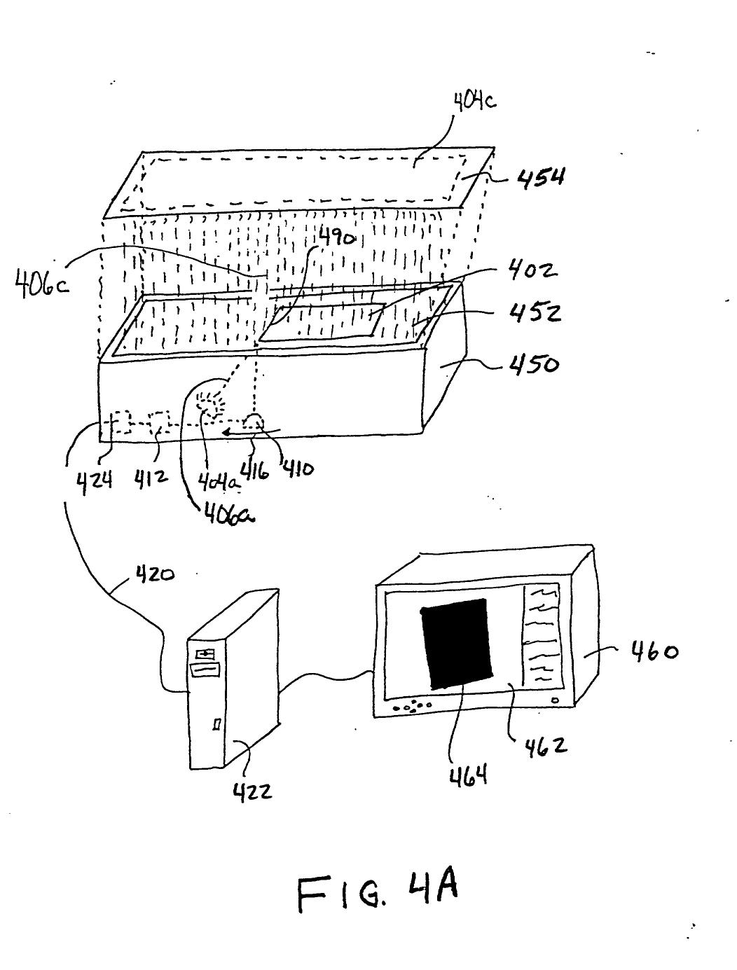

In the first embodiment, a document may be placed within a slide adapter 480 prior to being placed on the platen of a scanner. As shown in FIG. 4, in a context of documents 464 such as film, these documents 464 may be placed or otherwise inserted in a slide adapter 480 that blocks non-relevant image information areas of the document 464 such as the sprocket holes 482 in the representative film document 464. In turn, the document 464 comprising the slide adapter 480 is placed on the platen of the scanner and the scan is performed. The computer analyzes the pixels collected by the scanner that were sent to the computer.

In this configuration, the software of the scanner driver will recognize portions of the scanning image related to the slide adapter 480 as a surface deviation and discard this information prior to presenting a scan image to the user for subsequent manipulation. This method still requires the intervention of the user to place or otherwise insert each document 464 in at least one slide adapter 480. Therefore, additional alternatives for detecting surface deviations related to the edges of a document 464 are disclosed herein.

In a second embodiment, the present invention may utilize the backlighting source found in scanner transparency adapters. As shown in FIG. 4A, scanner 450 is equipped with at least one light source shown as light sources 404a and 404c in this particular embodiment. Those skilled in the art will recognize that at least one light source 404c is needed for transmissive scans and that only at least one additional light source such as light source 404a is needed for a reflective scan. The configuration shown in FIG. 4A is a preferred embodiment but this invention as described herein and claimed herein is not intended to be limited to this configuration.

Of note, light source 404c is incorporated in the scanner cover 454 to provide a transmissive source of light 406c that may be used independently or in conjunction with the another light source 404a to detect surface deviations related to the edge 490 of a document 402. In this embodiment, light source 404c projects light 406c through the platen 452 of scanner 450. A document 402 placed on the platen 452 of scanner 450 is held in place by a scanner cover 454 (shown in an exploded view herein) that presses document 402 against platen 452.

As light source 404c projects light 406c through platen 452, portions of this light 406c are not transmitted to at least one sensor 410 because the opaque nature of document 402 blocks the transmission of light 406c. Those skilled in the art will recognize that light source 404c is shown as a flat, stationary light source but could easily be a moving light source that travels in direction 416 in coordination with the movement of sensor 410. Sensor 410 registers the pixel information that is transported to the computer 422 for processing via sensor 412 and converter 424 by cable 420. As a carrier comprising at least one sensor 410 translates the length of the document 402 in direction 416, pixel information is recorded for the entire length of the platen 452, including the document image 464. The darkened document image 464 is created by document 402's interruption of the light path 406c from light source 404c.

The software of the computer 422 will be able to identify the edges of document image 464 by comparing to the relatively light image area 462 and determining the edges 490 of document 402. The image information collected from a reflective scan as fully detailed herein may be collected by a second pass with this backlit light source 404c deactivated.

The embodiment shown in FIG. 4A also allows for multiplexing or the incorporation of a reflective scan for image information related to the document image 464 in a single scanning pass. By incorporating at least one additional light source 404a, the image information associated with image content of document 402 may be collected during this same pass. The software of computer 422 should be able to discern the optical information received from different light sources 404a and 404c. Additionally, it is envisioned that at least one light source may utilize a different type of light source. For example, light source 404c could project infrared light, fluorescent light, ultra-violet light, or other light levels not being projected from light source 404a. In this configuration, computer 422 would be able to categorize the data received in these different channels and use the image generated from light 406c received to determine the edges while simultaneously collecting the image information from the light 406a for the document image 464.

In another embodiment, a single pass scan is possible in this configuration by rapidly strobing light source 404c in alternating intervals with light source 404a. Though any alternating arrangement is useful, it is envisioned that a frequency of about 300 Hz is preferred. In this configuration, the data collected by sensor 410 is categorized by computer 422 as image data associated with the transmissive, edge-detecting scan from light source 404c and reflective, image scan from light source 404a. The computer 422 can analyze the data from light source 404c as previously discussed to detect the edges of document 402.

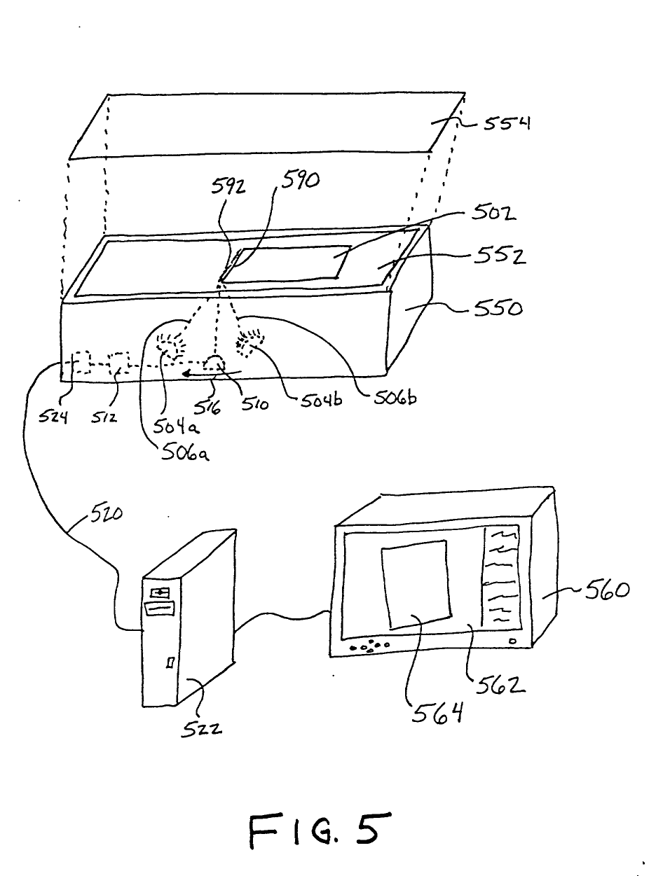

Turning to a third embodiment shown in FIG. 5, a scanner 550 equipped with a plurality of light sources 504a and 504b detects surface deviations related to the edge 590 of a document 502. The technology related to this differential illumination technique is described and claimed in U.S. patent application Ser. No. 60/158,672 filed October 8, 1999, entitled “Method and Apparatus for Differential Illumination Image Capturing and Defect Handling,” and U.S. patent application Ser. No. 60/158,710 filed Oct. 8, 1999, entitled “Method and System for Defect Detection Using Differential Illumination.” These Applications are hereby incorporated by reference in their entirety. In this embodiment, a plurality of light sources shown herein as light source 504a and 504b, project light 506a and 506b through the platen 552 of scanner 550. A document 502 placed on the platen 552 of scanner 550 is held in place by a scanner cover 554 (shown in an exploded view herein) that presses document 502 against platen 552.

As light sources 504a and 504b project light 506a and 506b toward document 502 via platen 552, portions of this light 506a and 506b are reflected onto at least one sensor 510. Sensor 510 registers the pixel information that is transported to the computer 522 for processing via sensor 512 and converter 524 by cable 520. As a carrier comprising at least one sensor 510 translates the length of the document 502 in direction 516, pixel information is recorded for the document image 564. Shadow area 592 is created by document 502's interruption of the light path 506b from light source 504b.

As at least one sensor 510 collects the image information, at least one shadow region 592 will be noted in document image 564. The shadow region 592 is created by the interruption of light 506b from light source 504b as shown in FIG. 5 is but one example of a shadow region 592 that will be created in document image 564. The similar occurrence will be noted in document image 562 about the edge of pre-scan area 562 in the areas associated with the other edges of document 502. This shadow region 592 has been shown by example of the shadow regions that will be created in pre-scan 562 about document image 564.

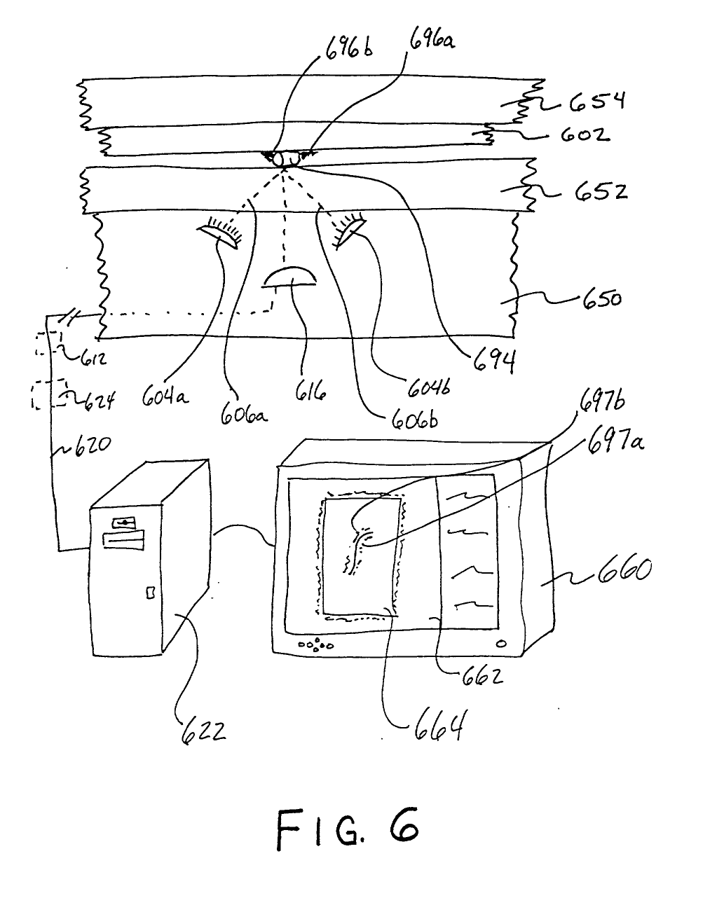

Other surface defects may create distinguishable shadow regions. For example, as shown in FIG. 6, a scanner 650 similar to scanner 550 shown in FIG. 5 is scanning a document 602 being held upon the platen 652 of scanner 650 by scanner cover 654. As shown, scanner 650 comprises a document 602 with a surface deviation not associated with an edge of a document 602. In this figure, light sources 604a and 604b have projected light rays 606a and 606b that have encountered a surface deviation 694, for example a hair.

Shadows regions 696a and 696b are created by surface deviation 694's interruption of light rays 606a and 606b, respectively. Shadow regions 696a and 696b are noted on document image 664 rather than pre-scan area 662 from monitor 660 via computer 622 from sensor 610 via converter 624 and sensor 612. This surface deviation 694 may be a hair, dent, scratch, or similar surface deviation not associated with an edge of document 602. These surface deviations are recognized by the scanner driver software being run on computer 622 that will evaluate the multiple shadow regions 696a and 696b shown on document image 664 as shadows 697b and 697a and recognize that these shadow regions 697b and 697a as not representing a surface deviation associated with an edge of the document 602.

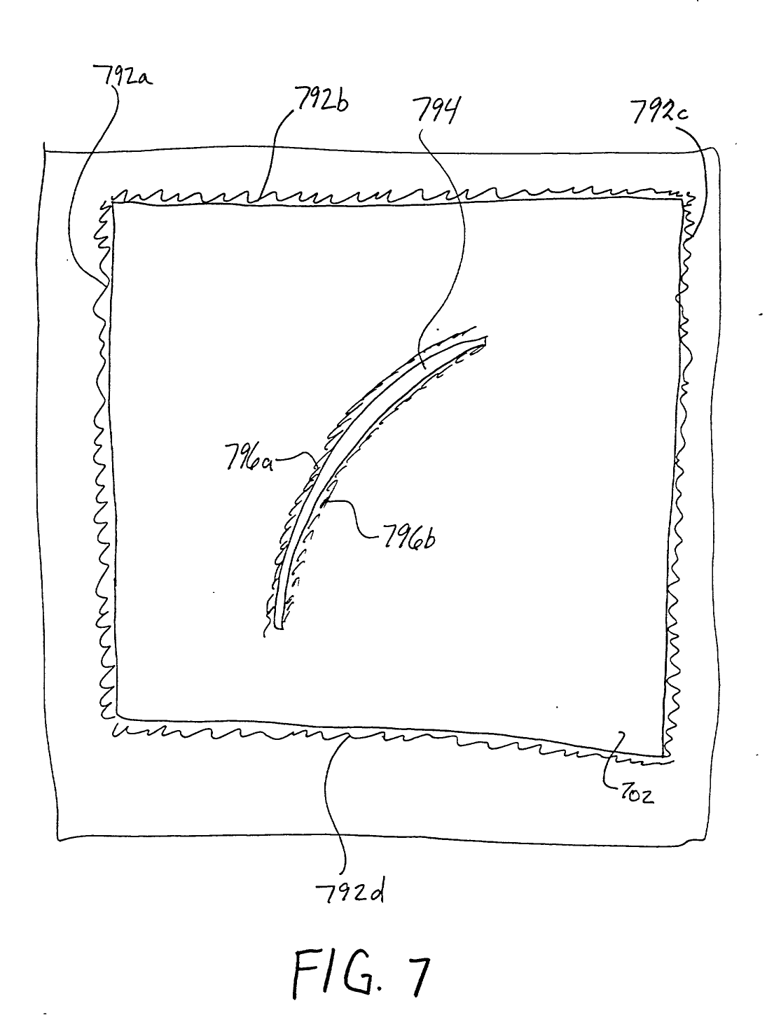

Moreover, as shown in FIG. 7, many non-edge related surface deviations such as hairs, scratches, and dents will be nonlinear. As shown, a hair 794 on the image of document 702 created shadow regions 796a and 796b. These shadow regions 796a and 796b being plural in nature are one indicator that a surface deviation related to an edge has not been detected.

Moreover, the nonlinear positioning of shadow regions 796a and 796b are a further indication that a nonlinear edge has been identified. Moreover, because image information is identifiable about hair 794, the software determines that the surface deviation detected as a result of noticing shadow regions 796a and 796b most likely does not comprise an edge.

Therefore, the surface deviation software analyzes additional shadow information provided in FIG. 7 and shadow regions 792a, 792b, 792c, and 792d. These shadow regions do not have complementary, nonlinear shadow regions nearby. The software surface deviation detection algorithms note that the linear nature of each shadow region more strongly indicates that an edge has been detected. Accordingly, the software generates a linear representation of these surface deviations and discards image information located opposite the image information presented in document image 702.

In the event that document 702 has been placed on the scanner platen such that only two surface deviation shadow regions were detected, the software interprets this information such that the user had placed the document 702 on the platen in a manner that only two edges were exposed to create shadow regions and the other two edges were defined by the scanning boundaries of the scanner platen. In this event, the software recognizes and defines linear edges, based on the surface deviation shadow regions, and classifies these deviations as edges. If the software does not properly recognize the boundaries, the user may manually override the detection and redefine the scanning area.

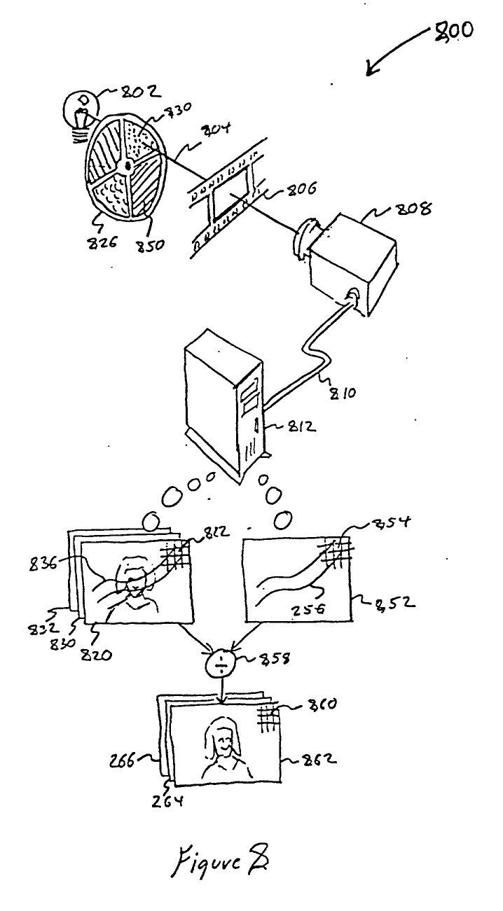

Turning to a fourth embodiment, infrared light allows for the detection of the edges of the document. Referring to FIG. 8, an infrared selective filter 850 is added to filter wheel 826 and used in conjunction with digital imaging device 808 to provide a fourth color memory, or channel, array 852 consisting of individual pixels 854 each containing a number representative of infrared brightness at the corresponding point of the film 806. The infrared memory array 852 contains the surface deviations 856 but no image 814 because the three dyes that create an image 814 in film 806 are all transparent to infrared light.

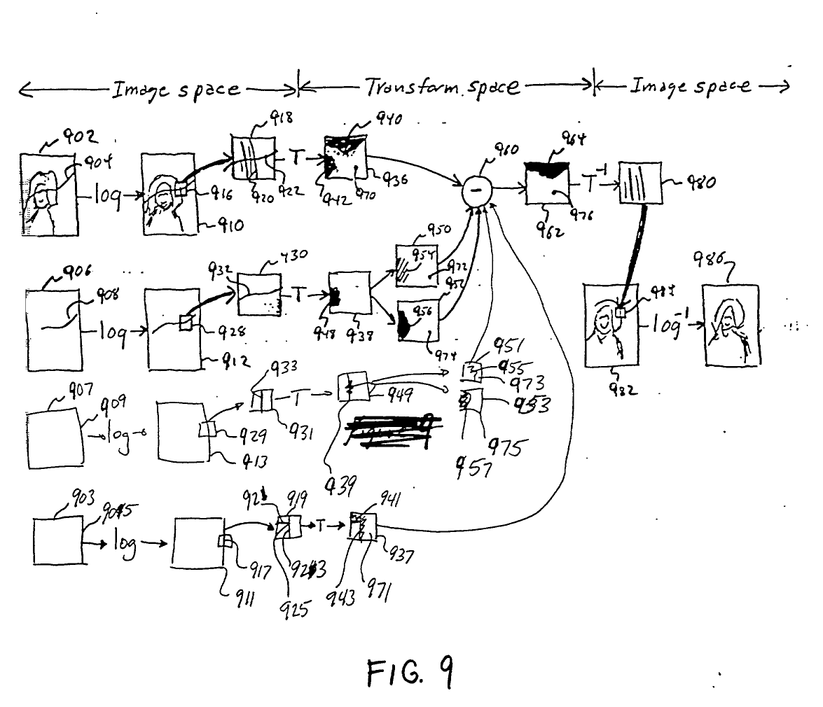

FIG. 9 illustrates a more detailed and complex method of isolating these surface deviations. In the context of surface deviation detection, infrared brightness can be used to determine the percent attenuation attributable to a surface deviation such as the edge of a document. For example, if the infrared record were attenuated from 100% with no defect to 90% with a defect present, and the visible record transmitted 9% with the defect present, the visible record would have transmitted 10% without the deviation. This method receives a visible image 902 containing a deviation 904, and an infrared image 906 of the same film with the deviation 908. The logarithm is taken of the data in each pixel in the images to produce the log visible image 910 and the log infrared image 912. Further processing is then performed on small overlapping blocks of the images, such as block 916, enlarged as block 918 to show vertical strands of hair 920 and the horizontal scratch 922.

Similarly, block 928 is enlarged as block 930 to show only the horizontal scratch 932. Next the visible block 918 and the infrared block 930 undergo a transform operation to yield the transformed visible block 936 and the transformed infrared block 938. The transform is selected to better isolate the defect scratch 922 from the hair 920. Although the hair 920 and the scratch 922 overlap each other in the visible block 918, they have different characteristics that can be used to distinguish them with the properly chosen transform.

Similarly, the reception of visible image 903 containing surface deviation 905 associated with an edge of document 903 and an infrared image 907 of the same film with a surface deviation 909. The logarithm is taken of the data in each pixel in the images to produce the log visible image 911 and the log infrared image 913. Further processing is then performed on small overlapping blocks of the images, such as blocks 917, and enlarged block 919 to show the linear nature of the surface deviation associated with edge 921 and the horizontal linear surface deviation associated with horizontal edge 923.

Similarly, block 929 is enlarged as block 931 to show only the horizontal edge surface deviation associated 933. Next, the visible block 919 and the infrared block 931 undergo a transform operation to yield the transform visible block 937 and the transformed infrared block 939. The transform is selected to better isolate the surface deviation associated with the edge 923 from the horizontal edge 921.

Although the horizontal edge 921 and the vertical edge 923 overlap each other at the corner 925, they have different characteristics that can be used to distinguish them with the properly chosen transform. In essence, the corner 925 of the edges of the document may benefit from the same technology used to determine the surface deviations associated with scratches like horizontal scratch 922 and hairs like hair 920. The following algorithm is useful for both. Moreover, it is envisioned that the following algorithm allow the separation of surface deviations associated with edges of the document and surface deviations associated with scratches, dents, hairs, or any other surface deviation not associated with the edge of the document because of their different characteristics.

Such characteristics include angle and frequency. These characteristics are distinguished by several linear transforms, including the discrete cosine transform (DCT), and the discrete Fourier transform (DFT), both well known in the art. The DFT has the best separation of diagonal angles, but the DCT handles boundary conditions better. Those skilled in the art recognize that these algorithms are representative of the algorithms that may be used.

In either the DCT or DFT, the vertical hair 920 produces a pattern 940 in transform space that is well separated from the pattern 942 produced by the horizontal scratch 922. One advantage of operating in transform space is the more complete removal of the defect pattern 942 with less damage to the image pattern 440 if they have less overlap.

Similarly, in either DCT or DFT, the vertical edge 921 produces a pattern 941 in transformed space that is well separated from the pattern 943 produced by the horizontal edge 923. The advantage of operating in transformed space is equally apparent for the edges as it was for the surface deviations associated with non-edge elements. There can be a more complete identification of surface deviations associated with horizontal edge and vertical edge patterns 943 and 941 with less damage to the image pattern 937 because of this calculation.

In practice, the isolation of the resulting image and deviation transform patterns will usually be less crisp than in this simple illustration; however, a transform such as the DCT will provide much better isolation than would be seen in the raw image. In short, the surface deviations related to the edges of the documents may be isolated.

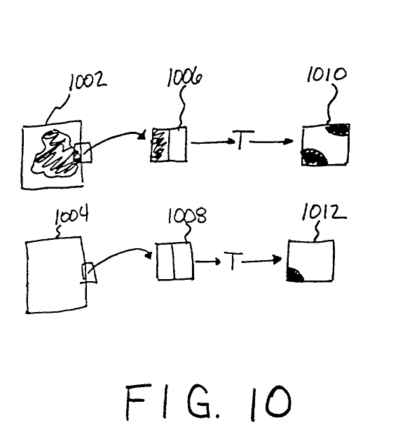

To begin, a visible scan is made in linear space. By linear space it is meant that the number representing the brightness of each pixel is a linear function of watts per unit area. In other words, twice the amount of light for a given period results in a pixel value twice as big. (In the case of most scanners that incorporate gamma correction, it would be necessary to square the scanned pixel value to undo the gamma correction inherent in the scan software, and thereby receive a pure linear value.) The linear visible scan is received in FIG. 10 as image 1002 along with a linear infrared scan 1004. The visible and infrared scans are divided into small blocks shown enlarged as visible block 1006 and infrared block 1008, respectively. Both of these blocks are transformed as described previously to produce transformed visible block 1010 and transformed infrared block 1012.

In the event that overlapping causes of surface deviations occur, such as an edge and a hair, this method of using DCT and/or DFT allows for the compensation and identification of the surface deviation related to the edges. Accordingly, this isolation technique allows for complicated scanning situations not previously undertaken by the prior art.

The preferred embodiment disclosed with reference to FIG. 10 uses a block transform structure; however, the use of such a structure is not a limitation in the practice of the present invention. Other structures permit the multiplication of infrared defect detail by a gain that is determined as a function of visible image brightness in such a way that deviations can be detected from highlights to shadows.

In practice, the scanner driver software can activate another light source rich in infrared light while extinguishing the original light source, and to make an infrared scan of the document so as to generate a distinct channel representing the infrared reflectance of the document. This method would simply the complex method previously discussed by only analyzing the surface deviations without the additional information related to the image on the document from interfering with the process.

By activating this second infrared scan of the document, much of the transform operation previously discussed herein is unnecessary. This infrared scan will create an image of the document devoid of information associated with the information comprising the document. In layman's terms, a silhouette of the document will be detected.

The computer software previously discussed herein operates to define the boundaries of the silhouette to find the surface deviations associated with the edges of the document. By observing the linear surface deviations and the infrared silhouette, the computer software program may define the edges of the document.

These methods exemplify the preferred embodiments and also allow for additional features to be incorporated once the edges of the document have been detected. Namely, reduction of the pre-scan image information not relevant to the document image is advantageous because the high resolution scanning operation of the relevant document image may be initiated faster and scan only the relevant document image area.

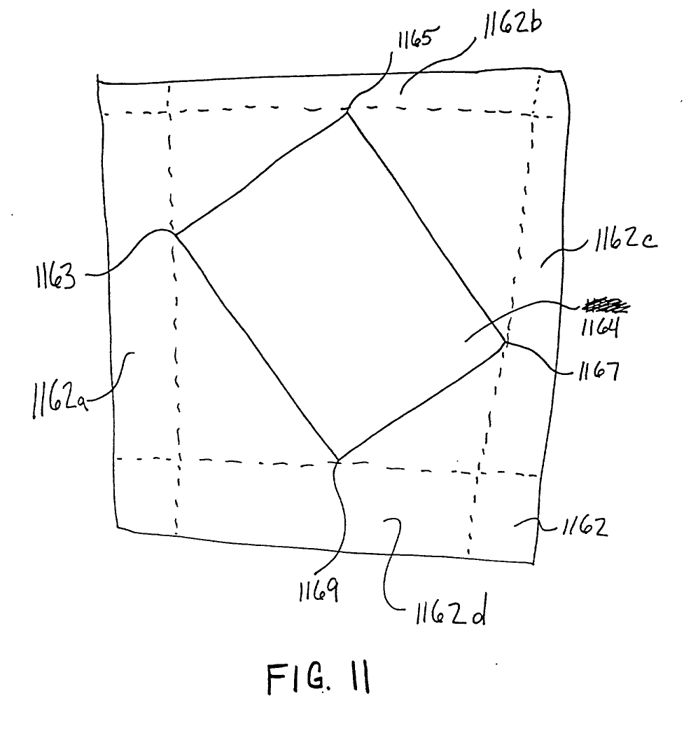

Referring to FIG. 11, once the surface deviations associated with the edges of the document 1102 have been determined, the amount of pre-scan area 1162 not associated with document image 1164 may be reduced. In the simplest embodiment, the software recognizes the greatest and least value in the horizontal and vertical directions that represents part of the document image 1164.

In FIG. 11, the greatest vertical point of document image 1164 is shown as point 1165. The least vertical point is shown by point 1169. The least horizontal point is represented by point 1163. Moreover, the greatest point associated with document image 1164 and the horizontal direction is point 1167.

As shown, the image information with a horizontal value less than the point 1163 herein defined as pre-scan area 1162a may be deleted or otherwise truncated. Accordingly, the image information greater than point 1165 herein defined as pre-scan area 1162b may be deleted. Moreover, the image information greater in horizontal value than point 1167 may be deleted to remove pre-scan area 1162c. Finally, the information with a vertical value less than point 1169 defined as pre-scan area 1162d may be deleted.

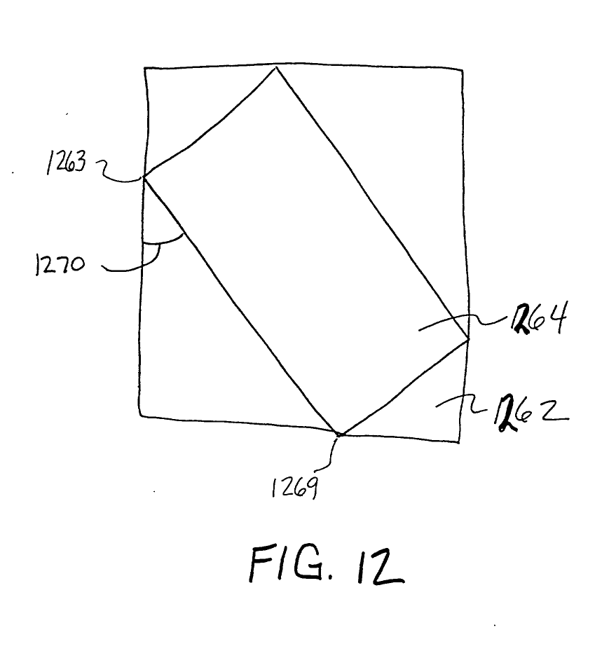

The resulting area as shown in FIG. 12 comprises a document image 1264 that occupies the majority of the scan area for viewing by the user. The pre-scan area not associated with document 1264 herein defined as pre-scan area 1262 has been reduced dramatically. FIG. 12 still demonstrates that angle of deviation 1270 could benefit from the rotational aspects defined herein. In repetition, the reduction of angle of deviation 1270 by the rotation of the relevant information comprised in document image 1264 will further allow the user to view a higher resolution scan of the information of interest as shown in document image 1264. In one method of reducing this angle of deviation, corners of document image 1264, noted by points 1263 and 1269 of document image 1264, may be aligned such that each point 1263 and 1269 comprises the same X coordinate information. If document image 1264 is rotated until both points have the same horizontal position, the angle of deviation 1270 will be reduced.

Those skilled in the art will recognize that variations in technology and approach to failure of the prior art are within the scope of this invention as an apparatus and a method. Namely, image detection systems recognizing deviations in surface may vary widely from the embodiments disclosed herein. Moreover, apparatuses capable of any of these variations of this method of use to detect surface variations are considered to be within the scope of the invention.

Accordingly, as the detailed description and the claims as claimed herein capture, it is intended that any variation within the scope of this invention may be captured. Whereas the present invention has been described with respect to specific embodiments thereof, it will be understood that various changes and modifications will be suggested to one skilled in the art and it is intended to encompass such changes and modifications as fall within the scope of appended claims.

What is claimed is:

1. A method for detecting deviations in the surface of a document comprising:
scanning the document to create an image of the document;
identifying at least one edge of the document by recognize surface deviations in the image.

2. The method of claim 1 further comprising discarding portions of the image that exist opposite to the identified edge of the document image.

3. The method of claim 2 further comprising presenting the non-discarded portions of the image.

4. The method of claim 1 wherein the document is scanned by infrared light.

5. The method of claim 1 which further comprises isolating the angle of identified edge.

6. The method of claim 5 which further comprises reducing the angle of the edge by rotating the image.

7. The method of claim 1 further comprising illuminating the document with a transparency adapter.

8. The method of claim 1, further comprising inserting the document into a slide adapter prior to scanning.

9. The method of claim 8, further comprising discarding the portions of the image associated with the image of the slide adapter.

10. The method of claim 1, wherein the document is scanned by a plurality of light sources.

11. The method of claim 10, wherein analyzing the information to recognize the deviations in the surface of the document that represent at least one edge of the document is accomplished by recognizing the shadows created by each light source and identifying shadows that represent edges.

12. The method of claim 11, wherein analyzing the information further comprises isolating the angle of edge.

13. The method of claim 3, further comprising rotating the image to reduce the angle of the edge after isolating the angle of the deviation.

14. A surface deviation detector comprising:
a scanner having a platen for the placement of a document;
at least one light source;
at least one sensor sensing light related to at least one surface deviation associated with an edge of the document.

15. The detector of claim 14 wherein the light source is capable of projecting infrared light.

16. The detector of claim 14 further comprising a slide adapter.

17. The detector of claim 14 wherein the light source is capable of creating shadows that are detected by the sensor.

18. The detector of claim 14 further comprising a processor for creating an image of the document capable of automatically rotating the image of the document.

19. The detector of claim 14 further comprising a processor for creating an image of the document capable of eliminating image not associated with the image.

20. The detector of claim 14 further comprising a processor for creating an image of the document capable of truncating information not associated with the document image.

21. The detector of claim 14 comprising two light sources.

22. The detector of claim 14 wherein the scanner automatically initiates a high resolution scan.

23. The detector of claim 22 wherein the scan can be manually overridden.

24. A scanner system comprising:
at least one light source operable to illuminate a document having edges; and
at least one sensor operable to detect the illumination from the document and the edges.

25. A scanner system comprising:
a low resolution scan system operable to detect edges associated with a document; and
a high resolution scan system operable to perform a scan of an area defined by the edges detected by the low resolution scan system.
